(19) United States
(12) Patent Application Publication
(10) Pub. No.: US 2020/0278661 A1
(43) Pub. Date: Sep. 3, 2020

(54) METHOD FOR MONITORING AN AUTOMATION SYSTEM

(71) Applicant: Endress+Hauser Process Solutions AG, Reinach (CH)

(72) Inventors: Michael Mayer, Oberwil (CH); Andreas Büchin, Lörrach (DE); Norbert Cornelsen, Wieslet (DE)

(21) Appl. No.: 16/753,860

(22) PCT Filed: Sep. 11, 2018
(86) PCT No.: PCT/EP2018/074472

§ 371 Date: Apr. 6, 2020

(30) Foreign Application Priority Data
Oct. 6, 2017 (DE) 10 2017 123 221.4

(51) Int. Cl. G05B 19/418; G06F 16/901

(52) U.S. Cl. CPC G05B 19/4183; G06F 16/901; G05B 19/41865; G05B 19/41845

(57) ABSTRACT

The invention relates to a method for monitoring a process automation system, a plurality of measuring points being provided in the system, said method comprising: detecting movements, of people located within the system and/or objects, especially robots, vehicles and/or machines, which are not located at the measuring points; calculating stay data containing moments of the stay and/or the respective duration of the stay, the respective people and/or objects at the individual measuring points on the basis of the detected movements; and evaluating the stay data in terms of defined noticeable problems.

The invention relates to a method for monitoring a process automation system, wherein a plurality of measuring points is provided in the system.

Field devices that are used in industrial facilities are already known from the prior art. Field devices are often used in automation technology, as well as in manufacturing automation. Field devices, in general, refer to all devices which are process-oriented and which supply or process process-relevant information. Field devices are thus used for detecting and/or influencing process variables. Sensor systems serve for detecting process parameters. For example, these are used for pressure and temperature measurement, conductivity measurement, flow measurement, pH measurement, fill level measurement etc., and detect the corresponding process variables of pressure, temperature, conductivity, pH value, fill level, flow etc. Actuator systems are used for influencing process variables. For example, these are pumps or valves that can influence the flow of a fluid in a pipe or the fill level in a tank. In addition to the aforementioned measuring devices and actuators, field devices are also understood to include remote I/O's, radio adapters, or, generally, devices that are arranged at the field level.

A variety of such field devices is produced and marketed by the Endress+Hauser group.

In modern industrial facilities, field devices are normally connected to higher-level units via communication networks such as fieldbuses (Profibus®, Foundation® Fieldbus, HART® etc.), for example. Higher-level units are control units, such as an SPS (storage programmable controller) or a PLC (programmable logic controller). The higher-levels units are used for process control as well as for commissioning the field devices, among other things. The measured values detected by the field devices, especially, by sensors, are transmitted via the respective bus system to a (or possibly several) higher-level unit(s) that further process the measured values, as appropriate, and relay them to the control station of the installation. The control station serves for process visualization, process monitoring, and process control via the higher-level units. In addition, data transmission from the higher-level unit via the bus system to the field devices is also required, especially for configuration and parameterization of field devices and for controlling actuators.

In the course of Industry 4.0 or IIoT (“Industrial Internet of Things”), the data generated by the field devices are also frequently collected directly from the field by means of what are known as data conversion units, which are referred to as “edge devices” or “cloud gateways,” for example, and are transmitted automatically to a central cloud-enabled database on which an application is located. This application, which inter alia offers functions for visualizing and further processing the data stored on the database, can be accessed by a user by means of the Internet.

By means of these methods, it is possible to monitor the system's electronic components, that is to say the field devices and control units. In these methods, however, the consideration of or the influence of purely mechanical components, for example tube connections, is ignored. Alteration to such mechanical components, for example in the event of accretion or leakage, could only be detected indirectly, for example via altered measuring characteristics of the field devices. Therefore, in the event of a fault, a long period of time is sometimes required in order to determine the exact cause of the fault.

Based on this problem, the invention is based on the object of providing a method which allows the cause of a fault to be determined quickly and reliably in a process automation system.

The object is achieved by a method for monitoring a process automation system, wherein a plurality of measuring points is provided in the system, comprising:
detecting movements of people located within the system, and/or of objects not located at the measuring points, especially robots, vehicles and/or machines;
calculating stay data containing moments of the stay and/or the respective duration of the stay, the respective people, and/or objects at the individual measuring points on the basis of the detected movements; and
evaluating the stay data in terms of defined noticeable problems.

The great advantage of the method according to the invention is that information which cannot be measured by field devices and control units is also obtained for finding the cause of the fault at measuring points in the system. Specifically, the whereabouts and stay times of people and objects in the system are detected and evaluated. For example, measured values of a flow meter which outside a defined standard interval could thus be explained in that, for example, a pipeline is clogged. The cause can be determined from the stay data. For example, it could be evident that a maintenance technician is at the measuring point at regular intervals—for example, in order to knock on the pipe with an object, which removes accretion inside the pipe. Via the stay data, it is clear that the maintenance technician had not been at the measuring point for a longer period of time before the fault occurred, as a result of which the accretion in the interior of the pipe had not been loosened.

The method can also be used in older, purely analog systems in which no digital data evaluation and diagnostic evaluation is available at all.

The stay data are calculated and evaluated by, for example, a higher-level system integrated into the control room.

A measuring point consists of one or more system components, for example a tank or a pipeline, and of at least one field device. Field devices within the meaning of the present invention have already been mentioned by way of example in the preamble of the description.

According to an advantageous embodiment of the method according to the invention, it is provided that the stay data are stored in a database. This is especially a database which is implemented in a cloud environment. Alternatively, the database is located locally in the system, for example in the control room, or in the system environment. According to a preferred embodiment of the method according to the invention, it is provided that the stay data are visualized in the course of the evaluation in a diagram, especially a heat map, in which the number of times of occurrence and/or the duration of stay of the people and/or objects at a respective measuring point is represented cumulatively. In this way, clusters are quickly apparent to an operator. For example, maintenance-intensive measuring points can be quickly identified in this way.

An advantageous development of the method according to the invention provides that the people and/or the objects are grouped by distinguishing features.

According to an advantageous embodiment of the method according to the invention, it is provided that the people are grouped based on authority and/or role, wherein the authority and/or the role is defined in a distinguishing feature which is attached to the person, especially as an article of clothing in a color which can be associated with the respective authority and/or role. Roles of a person are, for example, the function they perform, for example service/maintenance technician, process engineer, supplier, visitor etc. Certain areas of a system can be restricted to unauthorized persons. For example, explosion-protected areas may only be entered by specialists who have the appropriate expertise and the required protective equipment.

The article of clothing is, for example, a helmet or other easily recognizable article of clothing.

Furthermore, it is thus also possible to implement an alarm function in the system. In the event that people are registered in areas for which they are not authorized, an alarm is triggered.

According to a preferred embodiment of the method according to the invention, it is provided that the objects are grouped in the system according to the type of component and/or based on the function of the component. For example, the objects may be classified in the groups “vehicles,” “robots,” and “machines.”

According to an advantageous embodiment of the method according to the invention, it is provided that stay data is evaluated automatically, especially by means of an application linked to the database, wherein the result of the evaluation is output to an operator. The operator selects, in advance, criteria which are taken into account in the evaluation.

According to a preferred embodiment of the method according to the invention, it is provided that the stay data are evaluated, especially automatically, with respect to at least one of the following noticeable problems:
cumulative stay duration of people and/or at least one specific measuring point;
cumulative number of moments of people and/or objects at least one specific measuring point; and/or
stay of people and/or objects in a restricted area of the system.

An advantageous development of the method according to the invention provides that a prediction regarding an expected cumulative stay duration is calculated at least one measuring point.

Alternatively, further predictions or trends may also be calculated. For example, a pattern recognition or a probability calculation is used for this. Certain patterns can also be recognized via machine learning, and forecasts can be created on this basis.

According to a preferred embodiment of the method according to the invention, it is provided that the stay data are filtered before the evaluation or after the evaluation with respect to at least one of the following features:
filtering with respect to at least one distinguishing feature;
filtering with respect to at least one defined time period; and/or
filtering with respect to at least one measuring point.

In this instance, it can also be provided that various periods of time are faded out. An example which may be mentioned here is an “open doors day” at which the system can be inspected by otherwise unauthorized persons. This period of time has no influence on the evaluations and is therefore not considered.

According to an advantageous embodiment of the method according to the invention, it is provided that the stay data are linked before the evaluation to at least one data set of the following data:
weather data;
production data; and/or
financial data.

An added value can be created by linking the stay data to the further data set:
the influence of environmental values can be taken into account by means of the weather data. For example, it can be checked whether certain areas/measuring points of the system are more maintenance-intensive than others at high temperatures.
by means of the production data, for example, a cluster can be determined in the maintenance demand of a component of the system whose production date lies before/after a specific date.
cost-intensive/cost-effective areas/measuring points of the system can be identified by means of the financial data. For example, a maintenance-intensive measuring point does not necessarily need to be expensive—this is concerned more with the most cost-intensive measuring point of the installation, for example because of high material wear. From this it could be deduced in what range it makes sense to think about cost-reducing optimizations.

According to a preferred embodiment of the method according to the invention, it is provided that the stay data are evaluated with regard to at least one of the following noticeable problems:
at least one temperature range or a specific temperature;
at least one production date or a production period of components of the measuring points; and/or
with respect to the maintenance costs of the measuring points.

According to an advantageous embodiment of the method according to the invention, it is provided that the movements are detected on the basis of at least one of the following methods:
evaluating video images recorded by means of at least one video camera arranged in the system;
collecting GPS data, wherein the people and/or the objects are respectively equipped with at least one GPS module; and/or
detecting movements by means of at least one infrared motion detector arranged in the system.

Other types of motion detection are also possible, for example via contact points in the ground etc. It is also possible to combine different detection methods with one another. It goes without saying that an evaluation based on distinguishing features, especially based on the colors of the people's articles of clothing, is possible only in the event of an optical detection method.

A preferred development of the method according to the invention provides that the stay data additionally comprise trajectories of the individual people and/or objects. The travel/movement paths of the people/objects can thereby be seen.

The invention is explained in greater detail with reference to the following Figures. The following is shown:

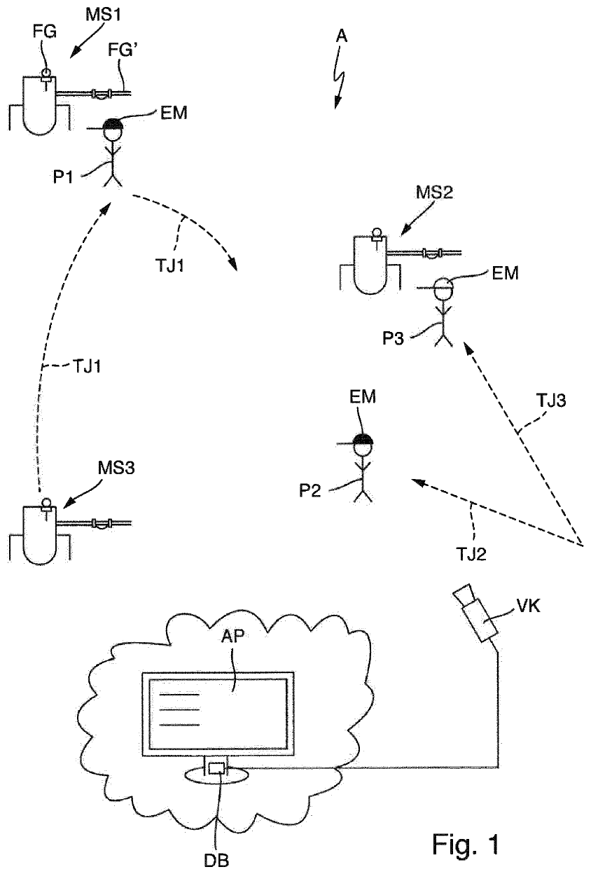

FIG. 1: an exemplary embodiment of the method according to the invention; and

FIG. 1 shows an exemplary embodiment of the method according to the invention. Parts of a process automation system A are depicted in this illustration. Specifically, three measuring points MS1, MS2, MS3 are involved. These respectively consist of a tank and a pipeline which discharges from the tank. In order to measure the fill level of the tank, a field device FG, for example a fill level measuring device using radar, is mounted on the tank. In order to measure the flow rate in the pipeline, a respective field device FG′is mounted, for example a flow meter according to the Coriolis principle.

The measuring points MS1, MS2, MS3 and the space located between the measuring points MS1, MS2, MS3 are recorded by at least one video camera VK. The recorded photos/videos are transmitted to a database DB. This exists especially on a cloud platform and can be contacted by an operator by means of the Internet. The database DB is connected to an application AP which evaluates the recordings.

The purpose of the recording is to collect stay data of people P1, P2, P3 of objects which stay in the system A, and to evaluate the stay data for noticeable problems. In the example shown in FIG. 1, two service technicians P1, P2 as well as a supplier P3 are currently in the system A. The application AP groups these three persons P1, P2, P3 using distinguishing features. Specifically, in this instance this involves the helmets of the people P1, P2, P3. The color of the helmet defines the role of the people P1, P2, P3 in the system A. Black hereby signifies the role of “service technician”; white hereby stands for the role of “supplier”.

The trajectories T1, T2, T3 of the people P1, P2, P3, and the moments of the stay and the duration of the stay by the people P1, P2, P3 at the measuring points MS1, MS2, MS3, are hereby recorded. The service technician P1 is on a routine tour to the individual measuring points MS1, MS2, MS3, wherein the service technician P2 is on the way to the measuring point MS2 where a problem has occurred, and wherein the supplier P3 is on the way to the measuring point MS2 to fill the tank.

The stay data determined in this way are likewise stored in the database DB. The stay data located in the database DB are evaluated by means of the application AP.

In a first step, the stay data are filtered. The filtering relates, for example, to a defined time period and/or to a defined role of people P1, P2, P3, and/or to one or more measuring points MS1, MS2, MS3.

The filtered stay data are then examined for noticeable problems. Such noticeable problems are, for example, a cumulative occurrence of a specific group of people at a measuring point MS1, MS2, MS3. It is also possible to check whether certain groups of people visit the measuring points MS1, MS2, MS3 at regular intervals.

In this way, it is possible to determine noticeable problems in the system A which cannot be determined by means of diagnostic values of the field devices FG, FG′, or in order to clarify diagnostic cases. For example, measured values of a flow meter which outside a defined standard interval could thus be explained in that a pipeline is clogged, for example. The cause can be determined from the stay data. For example, it could be apparent that the service technician P1 is at the respective measuring point MS1, MS2, MS3 at regular intervals, especially within the scope of the maintenance routine—for example in order to knock on the pipe with an object, which removes accretion inside the pipe. From the stay data, it is clear that the service technician P1 had not been to the measuring point MS1, MS2, MS3 for a longer period of time before the fault occurred, as a result of which the accretion in the interior of the pipe had not been loosened.

Advantageously, the stay data can be linked to further data sets, for example weather data, prognosis data, financial data, and/or to position data of the field devices. In this way, additional findings can be obtained.

### LIST OF REFERENCE SYMBOLS

A System

AP Application

DB Database

EM Distinguishing features

FG, FG′ Field devices

MS1, MS2, MS3 Measuring points

P1, P2, P3 People

TJ1, TJ2, TJ3 Trajectories

VK Video camera

1-14. (canceled)

15. A method for monitoring a process automation system, wherein a plurality of measuring points is provided in the system, comprising:
detecting movements of people located within the system or of objects not located at the measuring points, vehicles, or machines;
calculating stay data containing moments of the stay and/or the respective duration of the stay, the respective people, or objects at the individual measuring points on the basis of the detected movements; and
evaluating the stay data in terms of defined noticeable problems.

16. The method of claim 15, wherein the stay data is stored in a database.

17. The method of claim 15, wherein the stay data are visualized in the course of the evaluation in a diagram in which the number of moments of stay or the duration of stay of the people or of objects at a respective measuring point, is represented cumulatively.

18. The method of claim 15, wherein the people or the objects are grouped by distinguishing features.

19. The method of claim 18, wherein the people are grouped based on authority or role, wherein the authority or the role is defined in a distinguishing feature which is attached to the respective person.

20. The method of claim 18, wherein the objects are grouped in the system according to the type of component and/or based on the function of the component.

21. The method of claim 15, wherein the stay data is evaluated automatically, wherein the result of the evaluation is output to an operator.

22. The method of claim 21, wherein the stay data is evaluated automatically with respect to at least one of the following noticeable problems:
cumulative stay duration of people or at least one specific measuring point;
cumulative number of moments of people or objects at least one specific measuring point; or
stay of people or objects in a restricted area of the system.

23. The method of claim 15, wherein a prediction with regard to an expected cumulative stay time at least one measuring point is calculated.

24. The method of claim 15, wherein the stay data are filtered before the evaluation or after the evaluation with respect to at least one of the following features:
filtering with respect to at least one distinguishing feature;
filtering with respect to at least one defined time period; and
filtering with respect to at least one measuring point.

25. The method of claim 15, wherein the stay data are linked before the evaluation to at least one data set of the following data:
weather data;
production data; and
financial data.

26. The method of claim 25, wherein the stay data are evaluated with respect to at least one of the following noticeable problems:
at least one temperature range or a specific temperature;
at least one production date, or a production period of components of the measuring points; and
with respect to the maintenance costs of the measuring points.

27. The method of claim 15, wherein movements are detected on the basis of at least one of the following methods:
evaluating video images recorded by means of at least one video camera arranged in the system;
collecting GPS data, wherein the people or the objects are respectively equipped with at least one GPS module; and
detecting movements using at least one infrared motion detector arranged in the system.

28. The method of claim 15, wherein the stay data additionally comprise trajectories of the individual persons or objects.
